(19) United States
(12) Patent Application Publication
(10) Pub. No.: US 2009/0136137 A1
(43) Pub. Date: May 28, 2009

(54) IMAGE PROCESSING APPARATUS AND METHOD THEREOF

(75) Inventor: Tatsuo Kozakaya, Kawasaki (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/212,761

(22) Filed: Sep. 18, 2008

(30) Foreign Application Priority Data
Nov. 26, 2007 (JP) 2007-304227

(51) Int. Cl. G06K 9/46

(52) U.S. Cl. 382/195

(57) ABSTRACT

The invention includes a reference oint setting unit configured to extract a plurality of reference points from an input image; a pattern extractor configured to extract a local pattern of the reference points; a characteristic set holder configured to hold a group of characteristic sets having both local patterns of the reference points extracted from a learned image and vectors from the reference points to characteristic points to be detected; a matching unit configured to compare the local patterns extracted from the reference points and the group of characteristic sets and select the nearest characteristic set as a characteristic set having the most similar pattern; and a characteristic point detector configured to detect a final position of the characteristic point based on a vector from the reference point to the characteristic point included in the selected nearest characteristic set.

### CROSS-REFERENCE TO RELATED APPLICATION

This application is based upon and claims the benefit of priority from the prior Japanese Patent Application No. 2007-304227, filed on Nov. 26, 2007; the entire contents of which are incorporated herein by reference.

### FIELD OF THE INVENTION

The present invention relates to an image processing apparatus which detects a characteristic point included in an input image strongly and rapidly and a method thereof.

### DESCRIPTION OF THE BACKGROUND

To detect a characteristic point on an object having a certain shape such as a human face or a car in an image is very effective for not only detecting those objects but also recognizing the same. However, the appearance or the shape of the object such as the face or the car is common in characteristic point, but the local appearance or deformation varies according to the individual objects, so that absorbing diversified variations of these objects flexibly and detecting the characteristic point on the object with high degree of accuracy are important subjects.

In a well known generalized Hough transform, a reference point is detected by extracting positional information of the reference point to be detected from a table which is learned in advance using an edge gradient as a key at a characteristic point on edge points on the object and carrying out voting.

In B. Leibe and B. Schiele., “Interleaved Object Categorization and Segmentation”, in British Machine Vision Conference (BMVC'03), Norwich, UK Sep. 9-11, 2003.), a method of referencing a table using a local pattern of a characteristic point instead of the edge gradient as a key, voting an existence probability of the reference point to be detected from the characteristic point on the coordinates of the image and employing a point having the highest probability as a result of detection is proposed.

However, the method of obtaining the final position of the characteristic point based on the voting, following problems arise.

A first problem is that the destination of voting does not match when the partial deformation of the object occurs.

A second problem is that the voting space needs to be segmented into small segments in order to obtain an accurate position, but the density of the voting space is lowered correspondingly, so that the result may become unstable.

A third problem is that the number of axes increases in the voting space when the number of parameters (scale, the number of characteristic points of the object to be detected) to be expressed in the voting space is increased, so that the indexes are increased, and hence the calculating time or the stability of voting may be affected.

As described above, in the related art, there are problems such that the detection cannot be achieved satisfactorily in a case in which partial deformation is included since the position of the characteristic point to be detected is determined based on voting.

### SUMMARY OF THE INVENTION

In order to solve the problems in the related art described above, it is an object of the invention to provide an image processing apparatus which detects a characteristic point included in an input image strongly and rapidly without using a method of directly voting the position of the characteristic point to be detected.

According to embodiments of the invention, there is provided an image processing apparatus including: an input unit which inputs an image; a reference point setting unit configured to set a plurality of reference points for the input image; a pattern extractor configured to extract local patterns of the respective reference points in the input image; a set holder configured to hold characteristic sets including the local patterns of the reference points in a learned image, which are extracted for each of the plurality of reference points set in the learned image in advance, and vectors from the reference points to the characteristic point to be detected; a matching unit configured to compare the local patterns extracted from the reference points of the input image and the local patterns included in the characteristic sets respectively and select characteristic sets having the local patterns most similar to the local patterns of the input image as the nearest characteristic sets for the individual reference points of the input image; and a characteristic point detector configured to detect the position of the characteristic point in the input image based on the vectors included in the nearest characteristic sets selected for the individual reference points of the input image.

According to the embodiments of the invention, the characteristic point included in the input image is detected strongly and rapidly.

### BRIEF DESCRIPTION OF THE DRAWINGS

FIG. 1 is a block diagram showing a configuration of a first embodiment of the invention;

FIG. 2 is a drawing showing a method of setting reference points;

FIG. 3 is a drawing showing the setting of local patterns and vectors at the reference points on a learning image;

FIG. 4 is an explanatory drawing showing the vectors obtained for the reference points on the input image;

FIG. 5 is a block diagram showing a configuration of a second embodiment of the invention;

FIG. 6 is an explanatory drawing showing the removal of outliers of the vectors;

FIG. 7 is a block diagram showing a configuration of a third embodiment of the invention;

FIG. 8 is a flowchart of estimation of a characteristic point according to a third embodiment of the invention;

FIG. 9 is a drawing showing correction of the vector using a reference point;

FIG. 10 is a drawing showing the correction of the vector using a characteristic point pattern.

### DETAILED DESCRIPTION OF THE INVENTION

Referring now to the drawings, an image processing apparatus 10 according to embodiments will be described.

### First Embodiment

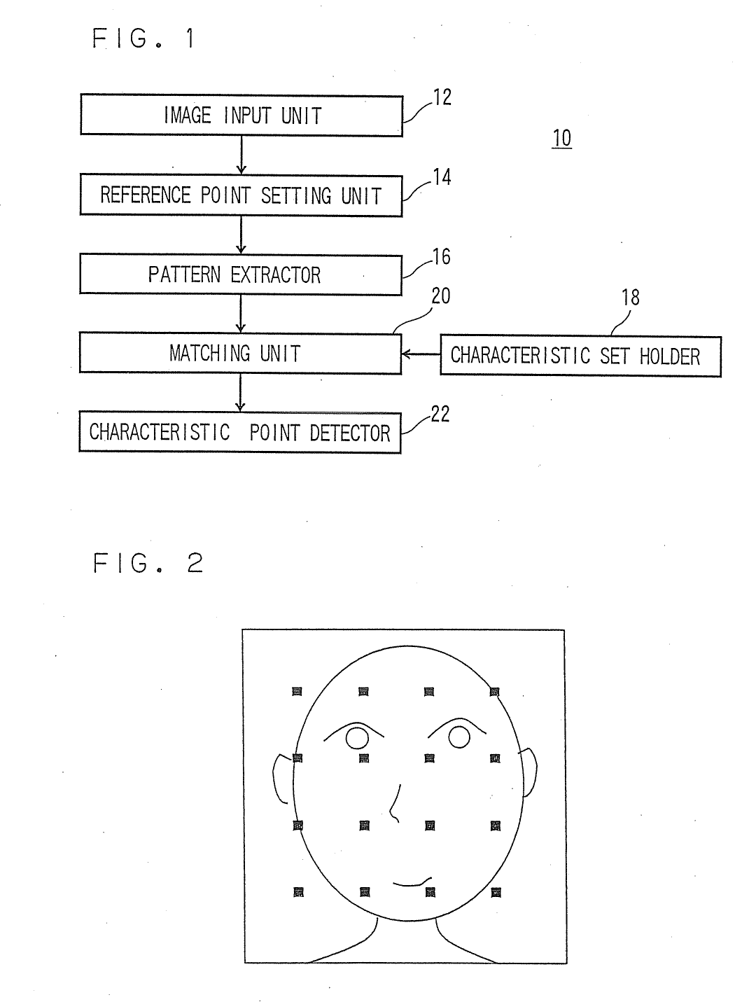

Referring now to FIG. 1 to FIG. 4, the image processing apparatus 10 according to a first embodiment of the invention will be described.

The configuration of the image processing apparatus 10 will be described based on the block diagram in FIG. 1.

The image processing apparatus 10 includes an image input unit 12 which inputs an image including an object to be detected (an input image), a reference point setting unit 14 configured to extract a plurality of reference points from the input image; a pattern extractor 16 configured to extract a local pattern of the reference points; a characteristic set holder 18 configured to hold a group of characteristic sets having both local patterns of the reference points extracted form a learned image in advance and vectors from the reference points to the characteristic points to be detected; a matching unit 20 configured to compare the local patterns extracted from the reference points and the group of characteristic sets and select the nearest characteristic set as a characteristic set having the most similar pattern; and a characteristic point detector 22 configured to detect a final position of the characteristic point based on a vector from the reference point to the characteristic point included in the selected nearest characteristic set.

Subsequently, the operation of the respective components from 12 to 20 will be described.

The image input unit 12 inputs an image including an object to be detected.

The apparatus which constitutes the image input unit 12 may be, for example, an USB camera or a digital camera.

A recording apparatus, a video tape, or a DVD which has a face image data shot and stored therein in advance may be used and, alternatively, scanning or shooting with other specific equipment is also applicable. It is also possible to input an image via a network or the like.

The input image obtained by the image input unit 12 is sent in sequence to the reference point setting unit 14.

The reference point setting unit 14 sets the reference points as benchmarks for relative positions of the vector, which indicate the direction of characteristic point to be detected in the input image.

How to detect the reference points are not specifically limited, and any detecting method proposed in the related art may be employed.

For example, as a method of detecting the reference points in the input image, a corner point detecting method proposed by Harris et al., (C. Harris and M. Stephens, “A combined corner and edge detector”, Proc. of Alvey Vision Conference, pp. 147-151, 1988.) is proposed. In this method, the corner angles are calculated based on the edge gradient in the image, and the pixels having a large corner angle are used as corner points.

It is also possible to employ points where the value calculated by the difference between smoothed images in difference scales referred to as Difference-of-Gaussian (DoG) becomes an extreme value as the reference points.

Alternatively, it is also possible to employ points selected by applying a method called “importance sampling” for the luminance distribution as the reference points.

The reference points may also be arranged in the input image at random.

In the first embodiment, a case in which the reference points are arranged in a grid-like pattern in the input image will be described for simplification. However, the following process may be handled in the same manner even though other reference point setting methods are employed.

FIG. 2 shows an example of a case in which the reference points are arranged in a grid-like pattern on a certain face image as the input image. The square points in FIG. 2 are the reference points.

Although it is not essential, a target object is preferably detected roughly as a pre-process of extraction of the reference points in terms of processing speed. For example, when detection of a pupil from the face in the input image is wanted, it is conceivable to detect the position of the face roughly using a face detector in advance.

The pattern extractor 16 extracts a pattern near the reference points extracted by the reference point setting unit 14 as reference point in the input image.

Luminance values of the input image may be used as the pattern without change, or may be transformed into the quantity of characteristics using the characteristic transform such as image processing filtering or the like.

The positional relationship between the positions of the reference points and the pattern does not necessarily have to be such that the reference points are at the center of the pattern, and may be offset arbitrarily.

In order to accommodate the change of the pattern, it is also possible to extract a pattern having a different scale, or a rotated pattern simultaneously, or to use an invariable quantity of characteristic for the scale or the rotation.

Here, a case in which the histogram in the edge gradient direction of pixels (Histogram of Oriented Gradients: HoG) described in N. Dalal and B. Triggs, “Histograms of Oriented Gradients for Human Detection”, IEEE Computer Vision and Pattern Recognition, pp. 886-893, 2005.) is used as the characteristic will be described.

First of all, rectangular patterns of M×N pixels in vertical and lateral direction, respectively, having the center at the reference point are cut out and transformed into the HoG characteristics. The HoG characteristics are referred to as local patterns of the reference points (or simply as patterns), hereinafter.

The pattern extractor 16 calculates local patterns in the input image for all the reference points and completes the process.

The characteristic set holder 18 holds a group of characteristic sets including the local patterns extracted from the learning image in advance and the vectors to the characteristic point to be detected in sets.

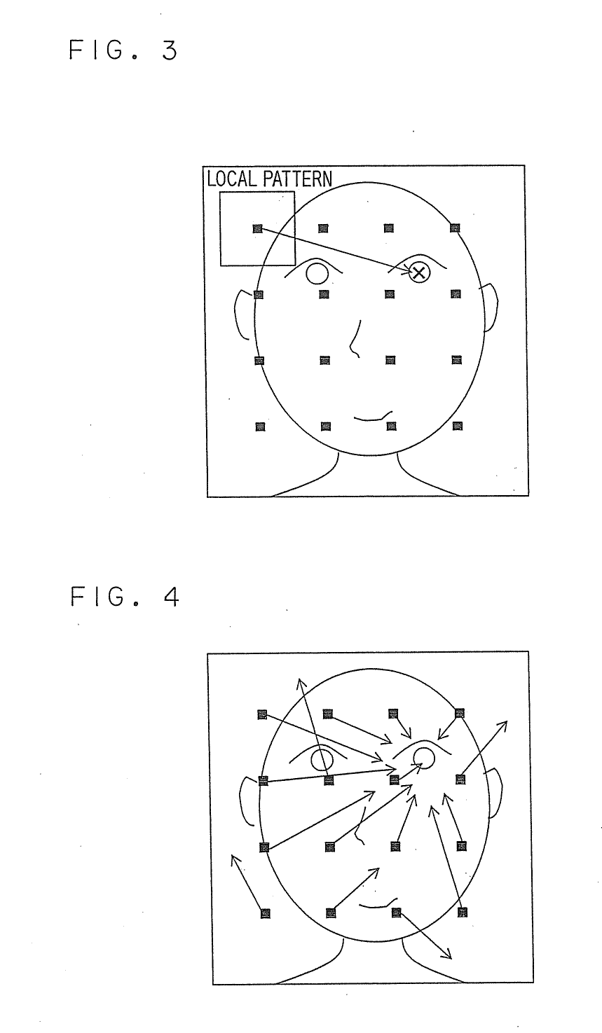

The characteristic point set will be described with reference to FIG. 3.

First of all, the reference points extraction and the pattern extraction described above are carried out for the learning image and the reference points and the local patterns thereof are extracted.

It is assumed that the position of the characteristic point to be detected is indicated on the learning image through the manual input or the like in advance. Therefore, the vectors from the reference points to the characteristic point can be defined. In FIG. 3, a vector from the reference point at the upper left in FIG. 3 to a left pupil characteristic point indicated by X sign is indicated by an arrow. The set of the local pattern at the upper left reference point and the vector to the characteristic point is referred to as the characteristic set.

The number of the characteristic points to be detected is not limited.

When a plurality of characteristic points (A points) exist, the number of defined vectors from the reference point to the respective characteristic points is A. The characteristic set in this case may be defined as the set of the local pattern of the reference point and A vectors.

When a contour line of the object is inputted and the object and the background are distinguishable, the reference points set on the back ground may not be set with the vector, but with a flag indicating that it is the background.

By setting the background flag, the unnecessary background may be removed from the input image by the matching unit 20 in the later step.

When using the HoG characteristics described above as the pattern, since the histogram of the directions of edge in the local pattern is formed, the main direction of the edge and the vector to the characteristic point may be associated to each other.

In other words, the vector is not defined as the vector from the reference point to the characteristic point, but is relatively defined as a vector rotated by an angle of θ toward the characteristic point from the direction of the edge of the local pattern, so that the vector becomes invariable with respect to the rotation of the local pattern.

The definition to be invariable with respect to the rotation of the vector as described above does not necessarily have to be the HoG characteristics, but may be any characteristics as long as it is the quantity of characteristics which enables definition of main directional component in the pattern.

The characteristic set holder 18 carries out the process shown above for all the reference points in all the learning images, calculates the group of characteristic sets and holds the same.

The group of characteristic sets may be held and used as is entirely, it is also possible to group similar characteristic sets (both the local patterns and the vectors are similar) as one group, or integrates a plurality of similar characteristic sets together using averaging, main component analysis, or a clustering method to reduce the quantity of memory for storing the characteristic set group.

The matching unit 20 compares the local pattern extracted from the input image and the characteristic set group and selects the most similar characteristic set.

First of all, it is assumed that the reference points and the local patterns at the respective reference points are extracted from the input image by the reference point setting unit 14 and the pattern extractor 16.

Then, a pattern matching is carried out between the local pattern of a certain reference point and the characteristic set group held by the characteristic set holder 18 to select the characteristic set having the most similar pattern.

Any method may be used for the pattern matching. For example, the well known nearest neighbor searching may be used. The most simple nearest neighbor searching calculates the distance between the patterns for all the registered data and outputs the pattern having the nearest distance.

In addition, there is also a nearest neighbor search for approximately calculate for speeding up (S. Arya, D. Mount, R. Silverman and A. Y. Wu: “An optimal algorithm for approximate nearest neighbor searching”, Journal of the ACM, 45, 6, pp. 891-923, 1998.) or a approximate nearest neighbor searching using a hash table (M. Datar, N. Immorlica, P. Indyk and V. Mirrokni: “Locality-sensitive hashing scheme based on p-stable distributions”, Proc. of the 20th Annual Symposium on Computational Geometry, pp. 253-262, 2004.) are proposed.

What to do when using these methods is to configure the group of characteristic sets held in advance into a tree structure, and to define the hash table for the characteristic set group.

Any matching methods proposed thus far may be applied in addition to the nearest neighbor search.

Hereinafter, the most similar characteristic set selected for a certain local pattern is referred to as “nearest characteristic set”. This is calculated for all the reference points (local patterns) in the input image and the corresponding nearest characteristic sets are obtained individually.

The characteristic point detector 22 detects the position of the characteristic point to be detected based on the vectors held by the nearest characteristic sets obtained for each of the reference points.

The nearest characteristic set corresponding to each of the reference points on the input image is obtained by the matching unit 20. As each of the nearest characteristic set has a vector, this is used as the vector from the reference point to the characteristic point to be detected.

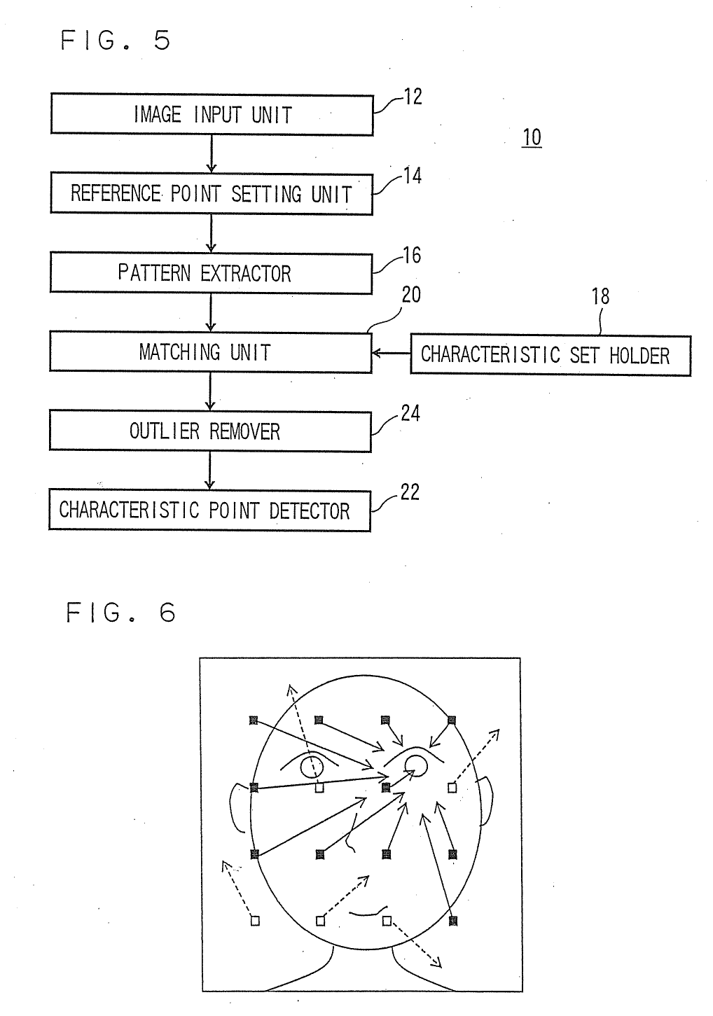

FIG. 4 shows an example of the vector of the nearest characteristic set obtained for each of the reference points. This is the case of detecting the left pupil characteristic point in the same manner as in FIG. 3.

When an adequate nearest characteristic set is selected for the local pattern by matching, the vector from the reference point to the characteristic point is obtained.

When the vector is defined at a relative angle with respect to the edge direction in the local pattern, it is transformed to a vector which indicates an absolute direction in the image using the edge direction of the local pattern.

Subsequently, an example of a method of calculating the position of the characteristic point from the geometric relation when the vector from the reference point is obtained will be described.

First of all, when there is n reference points in total, a straight line li passing through a point (xi, yi) and proceeds toward a point (ui, vi) is expressed in Expression (1);

lᵢ:aᵢx+bᵢy+c=0(aᵢ²+bᵢ²=1) (1)

where (xi, yi) is the coordinate of the i^{th} reference point, and (ui, vi) is the obtained vector.

In this case, the distance di from a given point (x, y) to the straight line li is as Expression (2).

Hereinafter, when simply written as “the distance from the point to the vector”, it means the distance di between the straight line passing through this reference point and proceeding in the direction of vector and the point.

dᵢ²=(aᵢx+bᵢy+cᵢ)² (2)

Therefore, the summation of distances E between the point (x, y) and the straight lines at all the reference points is expressed as Expression (3).

$$E ( x , y ) = {\sum }_{i = 1}^{n} {d}_{i}^{2} = {\sum }_{i = 1}^{n} {( {α}_{i} x + {b}_{i} y + {c}_{i} )}^{2} \qquad ( 3 )$$

The point having the smallest summation of distances E (x′, y′) must simply be determined as the final position of the characteristic point.

Even when there are a plurality of characteristic points to be detected, the same process may be applied by carrying out the operation of the characteristic point detector 22 by a plurality of times.

When detecting the plurality of characteristic points, since the characteristic set includes vectors corresponding to the respective characteristic points, what to do is to calculate the summation of distance between the straight line and the point (x, y) expressed by the reference point and the vector for each type of characteristic point and obtain the characteristic point (x′, y′).

According to the image processing apparatus 10 in the first embodiment, the final position of characteristic point is calculated not by voting the position of the characteristic point to be detected, but based on geometric calculation to obtain the vectors from the plurality of reference points in the image to the characteristic point to be detected and obtain the smallest distance in the group of vectors.

### Second Embodiment

Referring now to FIG. 5 and FIG. 6, the image processing apparatus 10 according to a second embodiment of the invention will be described.

The image processing apparatus 10 in the first embodiment calculates the characteristic point using the all the vectors in the characteristic point detector 22. However, in the second embodiment, the outlier is removed in advance before calculating the characteristic point.

The image processing apparatus 10 according to the second embodiment will be described based on the block diagram of FIG. 5.

The image processing apparatus 10 in the second embodiment carries out the same procedure as the first embodiment until the matching unit 20, but is different in that removal of the outliers of the vector obtained by the matching unit 20 is carried out by an outlier remover 24.

Hereinafter, assuming that the process until the matching unit 20 is completed and the nearest characteristic set (vector) is obtained for each reference point, the operation of the outlier remover 24 in the later stage will be described.

As shown in the example in FIG. 4, the matching unit 20 may select by mistake the nearest characteristic set having a vector deviated significantly from the position where the characteristic point should be located. Such outlying vectors, having a possibility to cause an error in calculation of the characteristic point, are removed in advance by the outlier remover 24, so that the accuracy of detection of the characteristic point is improved.

FIG. 6 shows an example of the removal of outliers. In this example, the arrows indicated by dotted lines in FIG. 6 are removed as the outliers. Various methods of removing outliers have been studied thus far, and hence any method may be employed. An example will be described below.

As a first method, the outliers may be removed by robust estimation. Accordingly, a method of removing the outliers by the robust estimation referred to as LMedS (Least Median of Squares) will be described.

First of all, F points of the reference points are selected at random, and a temporary characteristic point coordinate is calculated using F vectors at the selected reference points. The calculation of the characteristic point coordinate from the vectors is the same as the method carried out by the characteristic point detector 22 described above.

Subsequently, the error (distance) di with respect to the vectors at all the reference points is calculated using the temporary characteristic point coordinate. The distance di is the conformity for evaluating the vectors and the smaller the distance di becomes, the higher the conformity becomes. Then, a temporary characteristic point coordinate is evaluated using the LMedS reference expressed by Expression (4).

LMedS=min med(dᵢ²) (4)

where med is an operator which takes a median value of all the distances di.

Subsequently, the best characteristic point coordinate having the smallest LMedS evaluation value is calculated by repeating this process by the required times.

Then, the obtained best characteristic point coordinate is outputted as a final output.

Then, the vectors whose distance from the characteristic point exceeds a predetermined threshold value are removed as the outliers, and then the characteristic point coordinate is obtained again, so that the characteristic point coordinate is obtained with higher degree of accuracy. The threshold value may be determined based on a standard deviation a of the distance expressed by Expression (5).

$$σ = C \{ 1 + \frac{5}{n - F} \} med \vert {d}_{i} \vert \qquad ( 5 )$$

where C is a coefficient to correct the error and n is the number of reference points.

A value obtained by multiplying a by a constant value (for example, by 2.5) is determined as the threshold value, and the vectors having the distance di which is larger than this threshold value are removed as the outliers.

Then, the characteristic point detector 22 in the latter stage uses the vectors which are not removed as the outliers, and calculates the characteristic point as described in the first embodiment.

If necessary, the removal of the outliers and the detection of the characteristic point may be repeated by a plurality of times such as employing the obtained characteristic point as the temporary characteristic point, then returning to the outlier remover 24 and then removing the outliers.

As a second method, a method of using the similarity between the nearest characteristic set obtained by the matching unit 20 and the local pattern.

A characteristic set most suitable for the local pattern is selected at the time of matching. At this time, the distance and the similarity are obtained as the degree of matching.

When the similarity with respect to the threshold value of the nearest characteristic set selected at a certain reference point is smaller(low in similarity) than that of the nearest characteristic set selected at other reference points, it is highly likely selected by mistake, and hence is removed as the outlier.

According to the second embodiment, the outliers from among the vectors obtained by the matching unit 20, which may adversely affect the detection of characteristic point, are removed, and then the characteristic is calculated again, so that the calculation of the characteristic point with high degree of accuracy is achieved.

### Third Embodiment

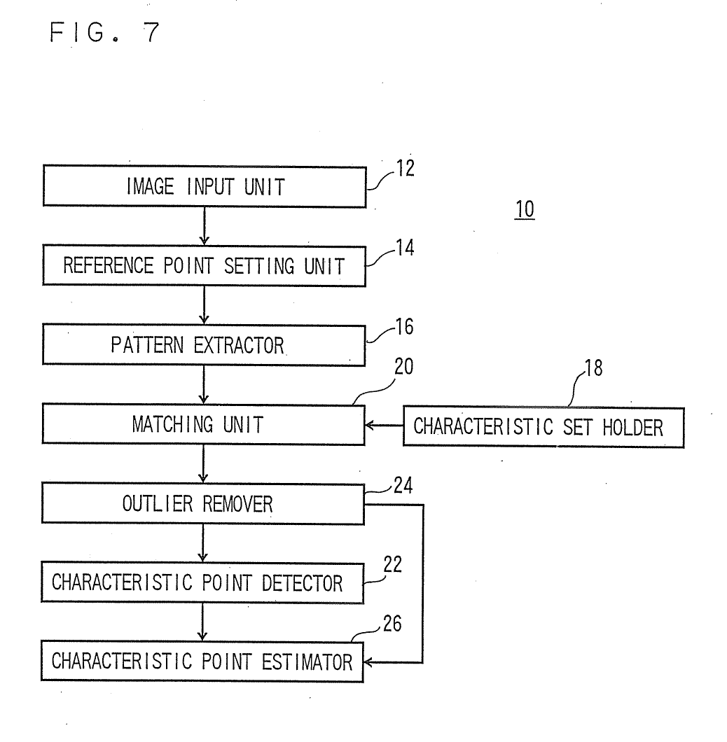

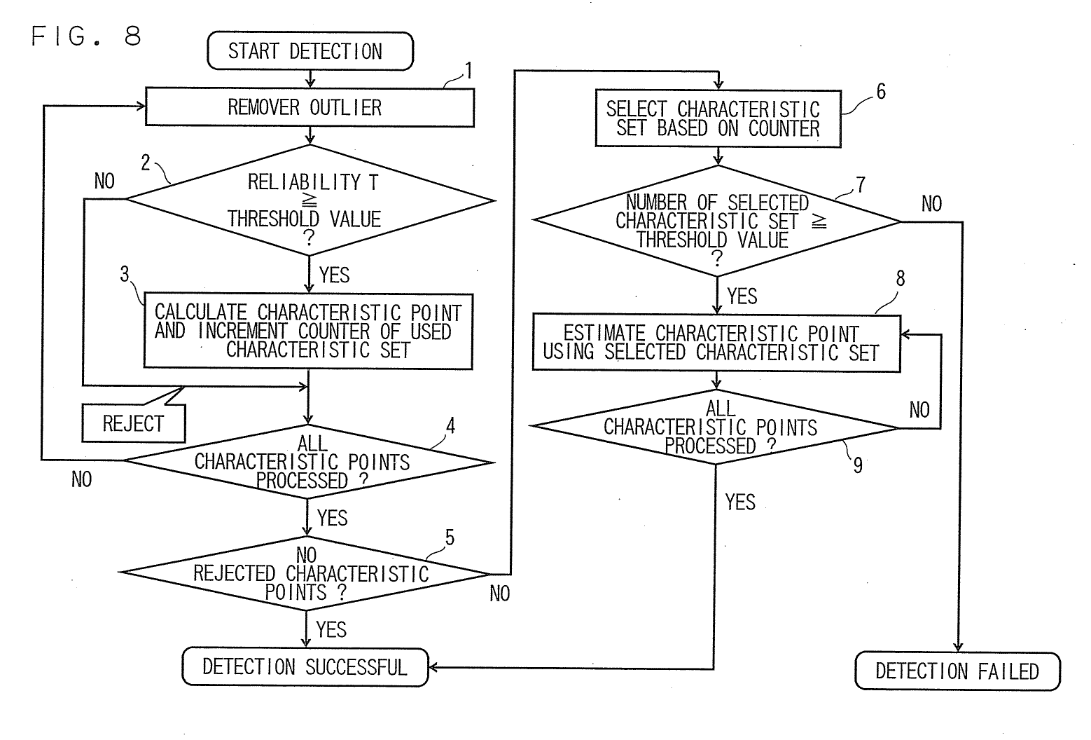

Referring now to FIG. 6, FIG. 7 and FIG. 8, the image processing apparatus 10 according to a third embodiment will be described.

In the second embodiment, when a number of vectors are determined as the outliers and removed as a result of the outlier removal, the number of vectors used in calculation of the characteristic point is reduced, and hence the result of calculation of the characteristic point highly likely becomes unstable, so that it is determined that the reliability of the accuracy of the characteristic point detection is low.

Therefore, the image processing apparatus 10 in the third embodiment determines the characteristic point having such low reliability of detection as undetectable (rejects), and uses other results of characteristic point detection to estimate the rejected characteristic point.

FIG. 7 shows a configuration of the image processing apparatus 10 according to the third embodiment.

The image processing apparatus 10 in the third embodiment carries out the same procedure until the matching unit 20, and the process of removing the outlier carried out by the outlier remover 24 and the process carried out by the characteristic point detector 22 are the same. However it is different in that the reliability is calculated according to the number of vectors removed by the outlier remover 24 in a characteristic point estimator 26, and if needed, estimates the characteristic point in the characteristic point estimator 26.

Subsequently, assuming that the process of outlier removal is completed in the outlier remover 24, the calculation of the reliability in detection of the characteristic point and the characteristic point estimator 26 in the later stage will be described. In the outlier remover 24, the reliability T in calculation of the characteristic point as a result of the outlier removal is defined by Expression (6);

$$T = \frac{( n - {n}^{′} )}{n} \qquad ( 6 )$$

where n is the number of reference points and n′ is the number of reference points removed as the outliers.

When the reliability T is equal to or lower than a certain threshold value, there are many outliers in comparison with the number of the outliers. Therefore, the group of vectors selected by the matching unit 20 have less regularity and hence it is determined that probability of convergence near the characteristic point is low. Even though the characteristic point is calculated under such circumstances, the number of vectors to be used for calculation is small. Therefore, the result of calculation becomes unstable, and hence the characteristic point detector 22 is skipped and the characteristic point is handled as undetectable (reject).

In a case in which the reject occurred when there is only one characteristic point to be detected (or when it is determined that all the characteristic points to be detected are determined as rejects), there is no other means for recovery, the detecting process is terminated.

In contrast, when part of the characteristic points are rejected when detecting a plurality of characteristic point, the characteristic point estimator 26 estimates the characteristic points rejected using information of the characteristic points which are successfully detected.

For example, in FIG. 6, part of the vectors is removed as the outliers, but the remaining vectors correctly indicate the direction of the characteristic point. In this case, the characteristic set having the vectors indicating the direction of characteristic point correctly is considered to have selected adequately from the group of characteristic sets for the given local patterns.

The characteristic set as such is expected to be able to indicate the direction of characteristic points correctly for not only the vectors for a certain characteristic point, but also for the vectors for other characteristic points.

Therefore, by calculating the rejected characteristic points using the characteristic set used for the characteristic points which are detected and not rejected, the positions of the characteristic points are estimated with high degree of accuracy.

More specifically, estimation of the characteristic points is carried out in the procedure shown below. FIG. 8 is a flowchart of characteristic point detection including the characteristic point estimation.

In Steps 1 to 3, when outlier removal is carried out by the outlier remover 24 and no characteristic point is rejected, and hence detection of the characteristic point is carried out by the characteristic point detector 22, the counter set to the characteristic set used for calculating the characteristic point is incremented.

In Step 4, the detection of characteristic point is carried out for all the characteristic point, and if there is no rejected characteristic point, the detection is considered to be successful and the procedure is terminated.

When there are rejected characteristic points in Step 6, the counter for each characteristic set of each of the reference points is inspected and, when the counter value is equal to or larger than the threshold value (for example, 50% the number of the characteristic points), the characteristic set is determined to be reliable.

In Step 7, the number of reliable characteristic sets is examined and, when it is equal to or lower than the threshold value (for example 30% or lower the number of reference points), it is determined that the number of reliable characteristic points is not sufficient, and hence the characteristic points not estimated and rejected are determined as having failed in detection.

In Step 7, when a sufficient number of characteristic sets having the counter value equal to or higher than a certain value, the characteristic point coordinates are detected by the characteristic point detector 22 using these characteristic sets in Step 8.

It is possible to use the common characteristic set for all the rejected characteristic points, and is also possible to use only the characteristic set of the reference points close to the position of the characteristic point depending on the position of the characteristic point coordinate (the position estimated by the prior probability).

In Step 9, when estimation for all the characteristic points are completed, the detection is considered to be successful and the procedure is terminated.

According to the third embodiment, by calculating the reliability by the outlier remover 24 and estimating the characteristic points having low reliability based on the result of detection of other characteristic points having high reliability, detection with higher degree of accuracy is achieved.

### Modification

The invention is not limited to the above-described embodiments, and the components may be modified and embodied in various manners without departing the scope of the invention in the stage of implementation.

It is also possible to form the invention in various modes by combining the plurality of components disclosed in the above-described embodiment as needed. For example, some components may be deleted from all the components shown in the embodiments, or the components shown throughout some different embodiments may be combined as needed.

Modifications are described below.

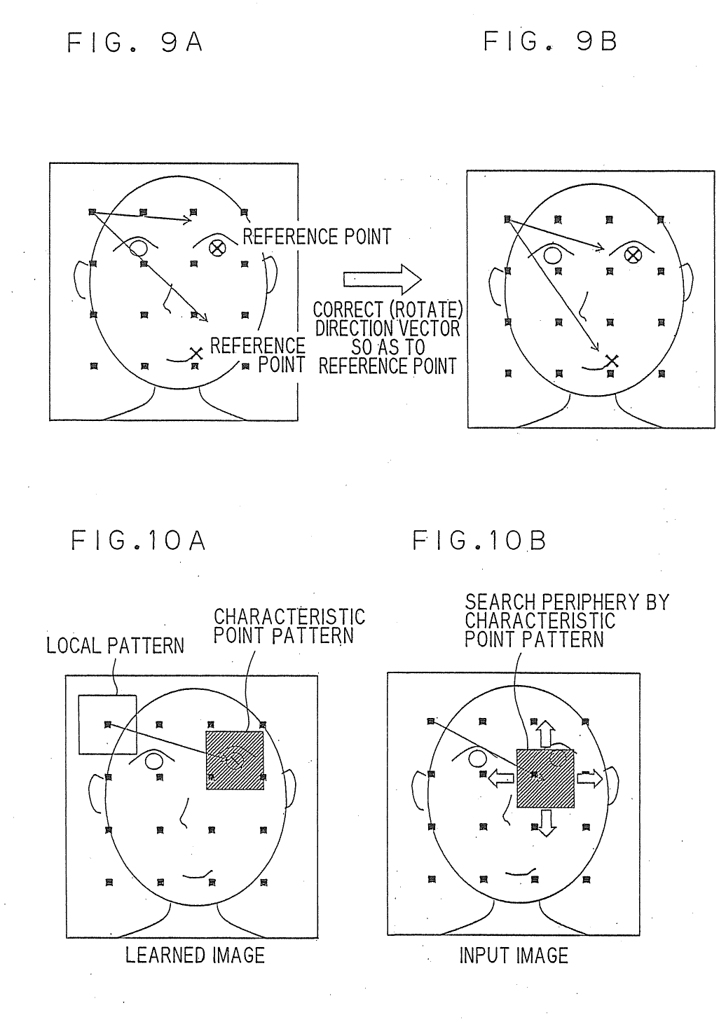

A modification 1 of the image processing apparatus 10 is described with reference to FIG. 9.

In the second embodiment, all the characteristic points to be detected are calculated. However, it is also possible to detect part of the characteristic points by a method of detecting humans or other detecting methods separately, calculate the outlier of the vector referencing to the separately detected characteristic point (hereinafter, referred to as an anchor point for differentiation), and select adequate vectors or correct the vectors adequately.

It is assumed that the characteristic point input means exists separately, part of the characteristic points to be detected by the characteristic point input means is inputted as an anchor point, and the anchor point is inputted manually, so that the anchor point have high degree of accuracy and hence are reliable.

The outlier remover 24 calculates the distance between a temporarily set characteristic point and the vector as the conformity, and determines the outliers with reference to the sum of the distance thereof. However, it is considered to determine the outliers using the anchor points instead of the temporary characteristic points.

Since the anchor point is supposed to be correct, those having a large distance of vector from the anchor point, that is, those having lower conformity may be determined as the outlier.

When there is a plurality of anchor points, it is possible to calculate the distances of the vectors from each of the anchor points and determine the outliers from the average value, or to correct the vector with reference to the anchor point and calculate the distance.

Referring now to FIG. 9, the method of correcting the vector will be described.

In FIG. 9, it is assumed that the left pupil and the left corner of mouth are inputted as the reference points, and the vectors (characteristic sets) at the reference points are obtained for the respective reference points (see the drawing on the left in FIG. 9).

In this case, the outliers are not determined simply by calculating the distance between the reference points and the vectors, but after transforming to make the distances between the references point and the vectors are minimized (see the drawing on the right in FIG. 9).

The transform may be achieved by rotating the vector about the reference point or may be achieved by any other transform. However, the transform which makes the distance between the reference point and the vector zero (for example, when an affine transform is applied to two vectors in a state in which only two reference points are obtained, the vector is always transformed to direct the direction of the reference point) is excluded.

Assuming that the rotational transform R about the reference point which minimizes the distance between the reference point and the vector is applied, whether or not the characteristic set at this reference point is the outlier is determined by the distance between the vector and the reference point obtained after having applied with the rotational transform R.

For other reference points as well, whether it is the outlier or not may be determined by obtaining the rotational transform which minimizes the distance from the reference point.

In this transform, the larger number of the reference points is preferable because the likelihood of the vector after transform is increased. Therefore, devices such as limiting the quantity of transform when the number of the reference points is small may be attempted.

Alternatively, when detecting the characteristic point near the reference point such as detecting the tail of the left eye when the left pupil is provided as the reference point, the vector may be transformed with the reference point close to the characteristic point as a reference even though a plurality of reference points are obtained.

When calculating the characteristic point by the characteristic point detector 22, the procedures to be carried out are the same other than applying the above-described transform in advance to the respective vectors.

The modification 2 of the image processing apparatus 10 will be described.

In the second embodiment, the outliers of the vector are calculated and those exceeding the threshold value are removed before calculating the characteristic point. However, the method of removing the outliers does not mean not to use the removed vectors at all by the characteristic point detector 22, but the removed vector may be weighed based on the outlying degree thereof to calculate the characteristic point according to the weight thereof.

The outlier remover 24 determines the outliers based on the distance di between the preset characteristic point and the vector. The weight wi may be set, according to the distance di, to 1 when di is zero, and to a value decreasing toward zero with increase in di. Determination of the outlier by the threshold value of the distance described in the second embodiment is the same as a definition; wi=1 when exceeding the threshold value and wi=0 when not exceeding the threshold value.

The characteristic point which minimizes the error Ew of Expression (7) may be obtained by the characteristic point detector 22 according to the obtained weight.

$${E}_{w} ( x , y ) = {\sum }_{i = 1}^{n} {w}_{i} {d}_{i}^{2} = {\sum }_{i = 1}^{n} {{w}_{i} ( {a}_{i} x + {b}_{i} y + {c}_{i} )}^{2} \qquad ( 7 )$$

The calculation of the reliability relating to the estimation of the characteristic point described in the third embodiment may be changed by using the weight as in Expression (8).

$${T}_{w} = 1 - \frac{1}{n} {\sum }_{i = 1}^{n} {w}_{i} \qquad ( 8 )$$

When the reliability Tw is obtained, the following detection of the characteristic point may be calculated in the manner described above.

Although the distance between the point (x, y) and the vector is expressed by the distance between the point and the straight line in the first embodiment, other measures may be used without problem.

For example, the vector (x−xi, y−yi) which connects the reference point (xi, yi) and the point (x, y) and the angle o of the vector (xi+ui, yi+vi) expressed by the reference point (xi, yi) and the vector (ui, vi) may be used. Alternatively, the distance d′i between the point (x, y) and the point (xi+ui, yi+vi) expressed by the reference oint (xi, yi) and the vector (ui, vi) may be employed.

$$\begin{matrix}{θ}_{i} = {cos}^{- 1} \{ \frac{( x - {x}_{i} ) ( {u}_{i} + {x}_{i} ) + ( y - {y}_{i} ) ( {v}_{i} + {y}_{i} )}{\sqrt{{( x - {x}_{i} )}^{2} + {( y - {y}_{i} )}^{2}} \sqrt{{( {u}_{i} + {x}_{i} )}^{2} + {( {v}_{i} + {y}_{i} )}^{2}}} \} & ( 9 ) \\ {d}_{i}^{′} = \sqrt{{\{ x - ( {x}_{i} + {u}_{i} ) \}}^{2} + {\{ y - ( {y}_{i} + {v}_{i} ) \}}^{2}} & ( 10 )\end{matrix}$$

The method of detection by the characteristic point detector 22 must simply be able to obtain the characteristic point whose summation is minimized in the measure based on the angle and distance (hereinafter, referred to as “distance measure”), and all the theories are applied in the same manner.

It is also applicable to obtain the characteristic point with a plurality of distance measures and then integrated by weighing addition or the like.

Alternatively, the distance measure may be changed accommodatively to the distance di between the point and the straight line when it is estimated that the partial deformation is large, and to the distance d′i between the point and point when it is estimated that the partial deformation is small.

For example, the distance d′i described above for the detected position of the characteristic point is obtained for all the reference points and the sum of the distances are determined as a convergence. The value of convergence is zero under the ideal conditions and increases with the partial deformation of the object or the matching error of the pattern. When the value of convergence is small, the characteristic point is calculated using the distance d′i, and when the value of convergence is large, the characteristic point is calculated using the distance di.

When the weighing sum of the both results of calculation is calculated according to the value of convergence, the accommodative detection of the characteristic point according to the partial deformation is enabled.

Referring now to FIG. 10, the modification 4 of the image processing apparatus 10 will be described.

In the first embodiment, the vector selected by the matching unit 20 may be corrected by the characteristic point pattern.

As shown in FIG. 10, when learning the characteristic set in the reference points using the learning image, the characteristic point pattern as the pattern near the characteristic point is stored together with the local pattern and the vector (see the drawing on the left in FIG. 10).

When detecting the characteristic point from the input image, the characteristic set corresponding to the reference point is selected by the matching unit 20, and the periphery of the coordinate indicated by the vector included in the characteristic set is searched by matching with the characteristic point pattern described above (see the drawing on the right in FIG. 10).

As a result of search, the vector is corrected so as to indicate the point having the highest similarity to the characteristic point pattern. After having carried out the correction of the vectors for all the reference points on the input image in the same manner, the position of the characteristic point is detected by the characteristic point detector 22.

The characteristic point pattern may be used in the outlier remover 24 described in the second embodiment.

As shown in the drawing on the right in FIG. 10, when it is assumed that the characteristic set is selected for the reference point on the input image, matching between the pattern on the coordinate indicated by the vector included in the characteristic set from the reference point and the characteristic point pattern is carried out, and the similarity which evaluates the likelihood to be the characteristic point of the point that the vector indicates is obtained.

Weather or not the vector is the outlier is determined with reference to the similarity.

The both the outlier determination with reference to the distance described in the second embodiment and the outlier determination by the similarity to the characteristic point pattern may be combined.

Although the face image is used as the image for detecting the characteristic point in the respective embodiments described above, the invention is not limited thereto, and may be applied to the case of extracting the characteristic point from the medical image of internal organs such as the heart, or the image of the car or the like.

What is claimed is:

1. An image processing apparatus comprising:
a reference point setting unit configured to set a plurality of reference points for an input image;
a pattern extractor configured to extract local patterns of the respective reference points in the input image;
a set holder configured to hold characteristic sets including the local patterns of the reference points in a learned image, which are extracted for each of the plurality of reference points set in the learned image in advance, and vectors from the reference points to a characteristic point to be detected;
a matching unit configured to compare the local patterns extracted from the reference points of the input image and the local patterns included in the characteristic sets respectively and select characteristic sets having the local patterns most similar to the local patterns of the input image as the nearest characteristic sets for the individual reference points of the input image; and
a characteristic point detector configured to detect the position of the characteristic point in the input image based on the vectors included in the nearest characteristic sets selected for the individual reference points of the input image.

2. The apparatus according to claim 1, further comprising an outlier remover configured to calculate, based on a temporary characteristic point in the input image and the vector included in the nearest characteristic set, the conformity indicating whether or not the vector is directed toward the temporary characteristic point in the input image and remove the vector whose conformity is lower than a first threshold value,
wherein the characteristic point detector detects the position of the characteristic point in the input image based on the remaining vectors that are not removed.

3. The apparatus according to claim 1, further comprising an outlier remover configured to calculate the similarity between the local pattern included in the nearest characteristic set and the local pattern of the input image and remove the nearest characteristic sets whose similarity is lower than a second threshold value,
wherein the characteristic point detector detects the position of the characteristic point in the input image based on the remaining vectors that are not removed.

4. The apparatus according to claim 2, wherein the outlier remover calculates the reliability which indicate the probability of detection of the characteristic point in the input image based on the conformities obtained for each of the vectors and, when the reliability is equal to or lower than a third threshold value, controls so as not to calculate the position of the characteristic point in the input image by the characteristic point detector.

5. The apparatus according to claim 4, further comprising a characteristic point estimator configured to estimate the position of the characteristic point whose reliability is equal to or lower than the third threshold value in the input image by using a plurality of the nearest characteristic sets used in detection of the position of other characteristic points different from the characteristic point whose reliability is equal to or lower than the third threshold value.

6. The apparatus according to claim 2, further comprising a characteristic point input unit configured to input part of the characteristic point in the input image as an anchor point, and
wherein the outlier remover sets the anchor point as the temporary characteristic point and calculates the conformity of the vector based on the position of the temporary characteristic point.

7. The apparatus according to claim 2, wherein the outlier remover calculates weights of the respective vectors according to the conformity of the respective vectors, and
the characteristic point detector detects the position of the characteristic point in the input image based on the respective vectors and the weights of the respective vectors.

8. The apparatus according to claim 1, wherein the set holder holds a characteristic point pattern indicating a pattern near the characteristic point in addition to the local patterns of the reference points and the vectors, searches a point having a maximum similarity to the characteristic point pattern from the periphery of the coordinate that is indicated by the vector included in the nearest characteristic set selected by the matching unit and corrects the vectors so as to direct the point found by the search.

9. The apparatus according to claim 1, wherein the set holder holds a characteristic point pattern indicating a pattern near the characteristic point in addition to the local patterns of the reference points and the vectors, and calculates similarities between a characteristic point pattern and the local patterns of the input image, and the characteristic point detector detects the position of the characteristic point in the input image based on the vectors and the similarities between the characteristic point pattern and the local patterns.

10. The apparatus according to claim 1, further comprising an input unit configured to input the input image.

11. An image processing method comprising:
a reference point setting step for setting a plurality of reference points for an input image;
a pattern extracting step for extracting local patterns of the respective reference points in the input image;
a set holding step for holding characteristic sets including local patterns of the reference points in a learned image, which are extracted for each of the plurality of reference points set in the learned image in advance, and vectors from the reference points to a characteristic point to be detected;
a matching step for comparing the local patterns extracted from the reference points of the input image and the local patterns included in the characteristic sets respectively and selecting a characteristic set having local patterns most similar to the local patterns of the input image as the nearest characteristic sets for the individual reference points of the input image; and
a characteristic point detecting step for detecting the position of the characteristic point in the input image based on the vectors included in the nearest characteristic sets selected for the individual reference points of the input image.

12. The method according to claim 11, further comprising an outlier removing step for calculating, based on a temporary characteristic point in the input image and the vector included in the nearest characteristic set, the conformity indicating whether or not the vector is directed toward the temporary characteristic point in the input image and removing the vector whose conformity is lower than the first threshold value,
wherein the characteristic point detecting step calculates the position of the characteristic point in the input image based on the remaining vectors that are not removed.

13. The method according to claim 11, further comprising an outlier removing step for calculating the similarity between the local pattern included in the nearest characteristic set and the local pattern of the input image and removing the nearest characteristic sets whose similarity is lower than a second threshold value,
wherein the characteristic point detecting step calculates the position of the characteristic point in the input image based on the remaining vectors that are not removed.

14. The method according to claim 12, wherein the outlier removing step calculates the reliability which indicate the probability of detection of the characteristic point in the input image based on the conformities obtained for each of the vectors and, when the reliability is equal to or lower than the third threshold value, controls so as not to calculate the position of the characteristic point in the input image by the characteristic point detecting step.

15. The method according to claim 14, further comprising a characteristic point estimating step for estimating the position of the characteristic point whose reliability is equal to or lower than the third threshold value in the input image using a plurality of the nearest characteristic sets used in detection of the position of other characteristic points different from the characteristic point whose reliability is equal to or lower than the third threshold value.

16. The method according to claim 12, further comprising a characteristic point input step for inputting part of the characteristic point in the input image as a reference point, and
wherein the outlier removing step sets the reference point as the temporary characteristic point and calculates the conformity of the vector based on the position of the temporary characteristic point.

17. The method according to claim 12, wherein the outlier removing step calculates weights of the respective vectors according to the conformity of the respective vectors, and
the characteristic point detecting step detects the position of the characteristic point in the input image based on the respective vectors and the weights of the respective vectors.

18. The method according to claim 11, wherein the set holding step holds a characteristic point pattern indicating a pattern near the characteristic point in addition to the local patterns of the reference points and the vectors, searches a point having a maximum similarity to the characteristic point pattern from the periphery of the coordinate that is indicated by the vector included in the nearest characteristic set selected by the matching step and corrects the vectors so as to direct the point found by the search.
